(19) United States
(12) Patent Application Publication
(10) Pub. No.: US 2009/0065428 A1
(43) Pub. Date: Mar. 12, 2009

(54) Disposable strainer

(76) Inventor: John C. Tomaini, Warwick, NY (US)

Correspondence Address: Brian L. Wamsley, Esq., 119 Highview Avenue, Nanuet, NY, 10954, US

(21) Appl. No.: 12/228,796

(22) Filed: Aug. 16, 2008

Related U.S. Application Data
(60) Provisional application No. 60/965,143, filed on Aug. 17, 2007.

(51) Int. Cl. B01D 35/28

(52) U.S. Cl. 210/471; 210/348; 210/500.1; 210/497.01; 210/485

(57) ABSTRACT

A disposable apparatus for straining food or other material is disclosed. Specifically, a strainer or colander made from a disposable material for convenient and limited use is disclosed. The strainer can be in any shape such as the shape of a bowl, box or triangular shaped vessel with holes or slots in the sides and/or bottom to allow liquids or flowable powders to pass through. The strainer is ideally made from an inexpensive, disposable material suitable for limited use and then discarded. Preferably, the material may also be capable of being rinsed one or several times. The strainer of this invention is also designed to be stackable or nest-packed, much in the manner of coffee filters.

This application claims priority from U.S. provisional application No. 60/965,143 filed Aug. 17, 2007.

### BACKGROUND OF THE INVENTION

The present invention relates to strainer or colander for a limited number of uses in the home, restaurants, camping or the like, for straining foods, liquids or flowable powders, such as flour or sugar.

Conventional strainers are designed to drain water from fruits, vegetables or other foods or flowable materials, generally in a kitchen in the kitchen sink. Because such strainers are used over and over again, they are made from sturdy, washable and durable materials, such as metals or plastics, so that they can be washed, dried and re-used at a later time.

However, cleaning such strainers can be inconvenient and sometimes time consuming. Conventional strainers are designed with holes, slots or other similar openings to allow water or other flowable material to pass through. Sometimes a strainer is little more that a bowl-shaped screen having a rim and a handle. Whatever particles of food or material becomes caught in the openings or attached to the strainer must be cleaned before the strainer is re-used. If liquids are used in the strainer, cleaning may become more problematic.

In addition, conventional strainers are not designed to be easily transported or stored, and usually there is not a need to have more than one or two in a family kitchen. With the present invention, the design of the strainer allows if to be stackable, much like disposable coffee cups, filters and paper plates, so that a number of them can be as conveniently stored as can one.

### SUMMARY OF THE INVENTION

A principle object of the present invention is to provide a strainer that is easily used one or several times, and is then discarded to avoid the necessity of cleaning or sanitizing the strainer. That is, the strainer of the within invention is constructed of inexpensive, lightweight and disposable material, such that the strainer can be inexpensively manufactured, used a few times and then discarded. Particularly, it is a principle object of this invention to provide a strainer that is made from paper, or a paper product, such as pulp (as known in the art), such that the paper has sufficient stiffness to maintain the shape and form of the strainer while being used. Other inexpensive, disposable materials such as plastic, pressed aluminum, aluminum foil or metal alloys can also be used. The strainer of this invention is also suitable to be made from re-cycled paper or plastics, or biodegradeable materials.

It is a further object of this invention to provide a disposable strainer that is easily storable. That is, the strainer are configured so that they be stacked one on top of another, in the manner of paper coffee cups, filters, or paper plates, bowls and disposable plastic bowl, so that they may be conveniently stored in a minimum of space.

A disposable strainer according to the embodiments of this invention allows the user to easily select a strainer from the top of a storable stack of strainers and use the strainer once and then conveniently discard it. If desired, and depending on what materials are used in the strainer, the strainer may be rinsed, dried and re-used one or several more times. The strainer is particularly useful in the kitchen in homes, boats, restaurants, delicatessens, or where lightweight and ease of disposal are desirable, such as hiking and camping.

The strainer comprises a body made of an inexpensive, disposable material such as paper, paperboards, cardboard, pressed aluminum or other metal or biodegradable plastic. The body is generally circular in shape, such as the shape of a bowl, but can also be square, triangular or any other convenient shape. The body contains holes or openings of sufficient size and shape to allow water to pass through, and also flowable solids or viscous liquids.

The strainer also has a top outer rim on the upper edge or circumference of the body to help provide rigidity to the shape of the strainer and which can also function as a handle. In some embodiments, the top rim can be configured to accept snap-lock plates. Made of the same material as the body, the top rim is molded onto the body as the body is manufactured, allowing for simplicity in manufacturing.

In a preferred embodiment, the strainer body also comprises vertically aligned ribs to help provide vertical support. In addition, bottom ridges on the bottom provide additional strength and allow the strainer to be set down on a table, counter or in sink. The bottom ridges are configured to allow water and other flowable materials to pass. In a preferred embodiment of the strainer, the vertical ribs connect with the top rim and the bottom ring. Similar to the top rim, the vertical ribs and bottom ring are made of the same material as the body, and are formed together with the body during the manufacturing process.

The disposable strainer can be of virtually any size, but typically smaller sizes are of more practical use. Specifically, the strainer can be from about 3″ to about 36″ in diameter, or measured cross-wise if the strainer is not completely circular. The height of the strainer is in direct proportion to the diameter and can be from about 2-3 inches to about 8-10 inches.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a side view of a preferred embodiment of the invention;

FIG. 2 is a to view of the embodiment of FIG. 1;

FIG. 3 is bottom view of the embodiment of FIG. 1;

FIG. 4 is a view of an embodiment of the invention;

FIG. 5 is a view of a further embodiment of the invention; and

FIG. 6 is a view of an embodiment of the invention illustrating a plurality of strainers in a stacked configuration.

### DETAILED DESCRIPTION OF THE PREFERRED EMBODIMENTS

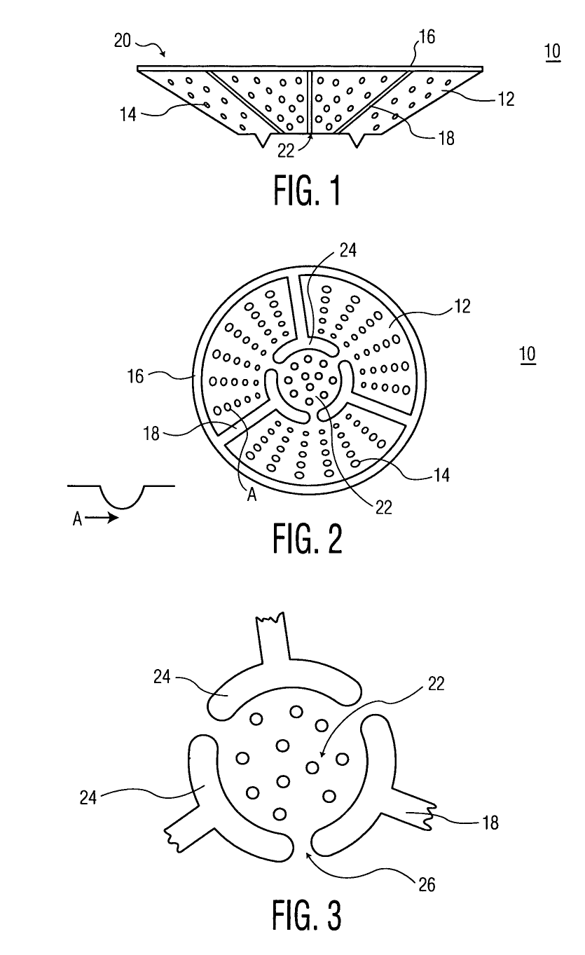

The preferred embodiments of the present invention will now be described with reference to FIGS. 1-6 of the drawings. Identical elements in the various figures are designated with the same reference numerals.

FIGS. 1-3 illustrate a first preferred embodiment of the disposable strainer of the present invention, generally designated by the reference number 10. The strainer comprises a body 12 made of an inexpensive, disposable material such as paper, paperboards, cardboard, pressed aluminum or other metal or biodegradable plastic. Body 12 has an upper opening 20 and a closed bottom 22. The body 12 is generally circular in shape, such as the shape of a bowl, but can also be square, triangular or any other convenient shape. It can be formed in a manufacturing process by means known to those of skill in the art, but generally molding or pressing the body materials in a form of the desired shape could be used. The body contains holes or openings 14 of sufficient size and shape to allow water to pass through, and also flowable solids or viscous liquids. The holes can be of any number, size or shape desired.

The strainer 10 also has a top outer rim 16 on the upper edge or circumference of the body to help provide rigidity to the shape of the strainer 10. Top rim 16 can also function as a handle. Made of the same material as the body, the top rim is molded onto the body as the body is manufactured, allowing for singular construction and simplicity in manufacturing.

In the preferred embodiment, the strainer body 12 also comprises vertically aligned support ribs 18 to help provide vertical support. The support ribs 18 are an integral part of the strainer body 12, and are also molded into the strainer body as the body is manufactured. Support ribs 18 can be made as solid, cylindrical structures, or as hollow, semicircular cylinders. In a preferred embodiment, the vertical ribs 18 are molded as semi-circular depressions in the strainer body 12. In FIG. 2, inset, is a cross-sectional view along axis “A” of such a vertical rib. In addition, the strainer body 12 has bottom support ridges 24 on the bottom 22 to provide additional strength and allow the strainer to be set down on a table, counter or in sink. The bottom support ridge 24 can be a single circular support ridge, or it may be comprised of a series of support ridges, arrange circularly on the bottom 22. See FIG. 3. The preferred number of bottom ridges is 3 or 4. When there are more than one bottom ridges, the bottom ridges 24 are spaced apart to contain openings 26 therebetween to allow water and other flowable materials to pass when the strainer 10 is sitting on a hard surface, such as a counter or in a kitchen sink. In the preferred embodiment of the strainer, the vertical ribs connect with the top rim and the bottom ring. Similar to the top rim, the vertical support ribs 18 and bottom ridges 24 are made of the same material as the body, and are formed together with the body during the manufacturing process.

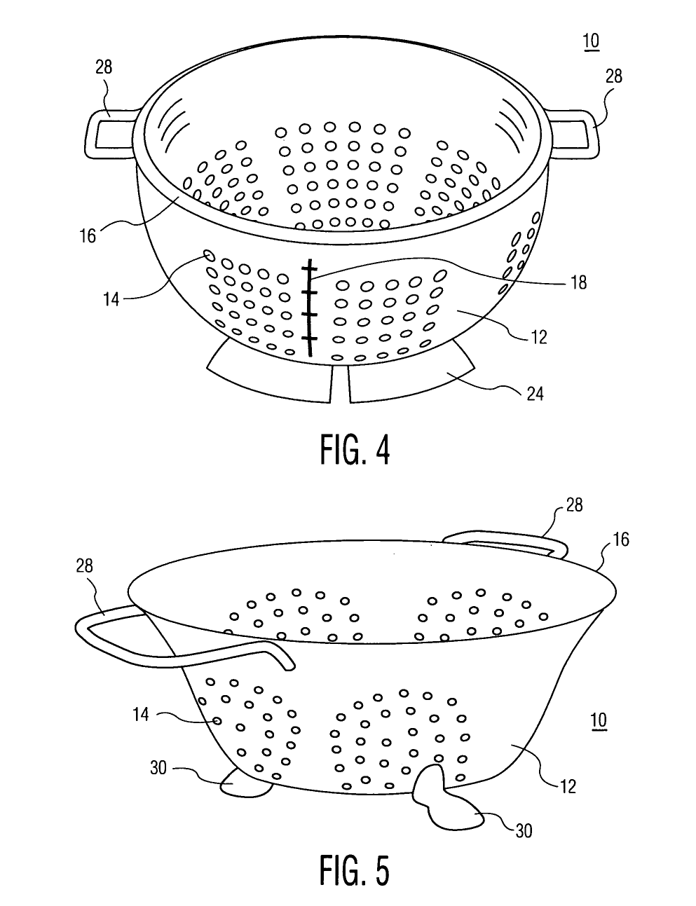

FIGS. 4 & 5 illustrate further preferred embodiments of the invention. Specifically, top rim 16 can either function as a handle itself, or have one or more handles 28 affixed thereto. As also shown in FIG. 4, vertical ribs 18 can be of a different configuration, such as a vertical ridge. The strainer body 12 can also have a plurality of feet 30, in place of the bottom support ridges 24.

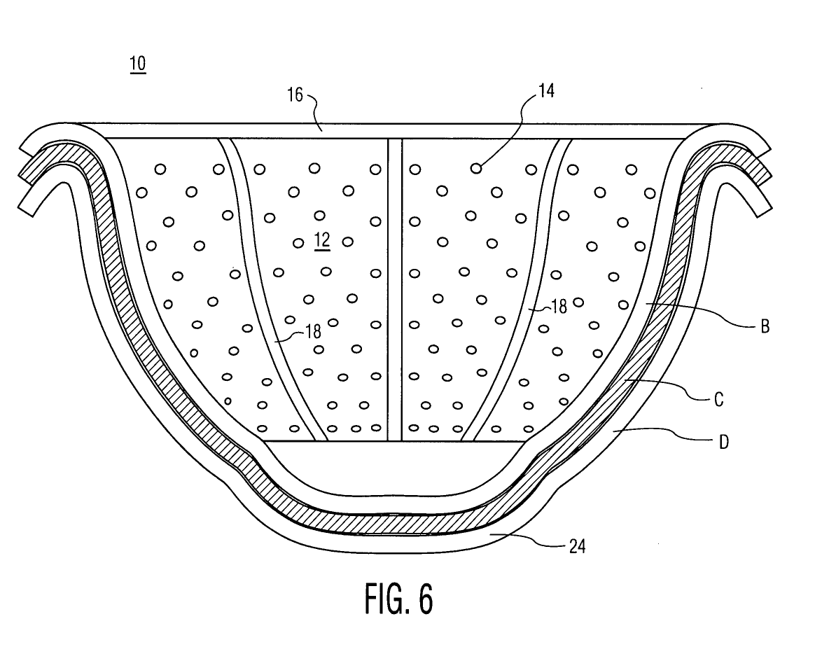

FIG. 6 is a further preferred embodiment of the invention and illustrated a series of strainers 10 in a stacked formation. Specifically, FIG. 6 discloses three strainers 10, designated B, C and D stacked one within the other in vertical alignment. The strainers themselves can be of any of the embodiments described herein, and can be stacked in any number as desired.

The disposable strainer of this invention is constructed of a lightweight, inexpensive material so that the strainer may be used a small number of times, up to about six times, and is then discarded without concern to cost. That is, the disposable strainer can be manufactured so that a large number of them can be produced cheaply, thus providing an advantage over conventional strainers. It is contemplated that the disposable strainer of this invention can be made form a variety of such inexpensive, diposable materials known to those of skill in the art, some examples being paper, pulp, re-cycled paper, cardboard, plastic, biodegradeable plastic, re-cycled plastic, aluminum foil, pressed aluminum or pressable alloy metal. When the term “paper” is used herein, it means a type of paper or paper product suitable for use in the strainer as described herein. For example, the paper should have an appropriate stiffness, such as the type of paper used in paper plates or cups. The paper could have a coating on it to resist penetration of water, such as also seen on paper plates and cups that are common today. Other types of papers can be those used in paper plates or cups that are specifically designed to hold hot liquids or foods. When the term “pulp” is used herein, it refers to the type of paper commonly used to form disposable paper carrying trays, such as those used in fast food restaurants, as known to those of skill in the art. When the term “aluminum” or “aluminum foil” is used herein, it refers to a lightweight, thin aluminum of the type that is commonly used to form disposable aluminum trays or roasting pans, which are typically press-formed or molded. Other types of inexpensive metal alloys can also be used.

In the preferred embodiment of the invention, the strainer body, top rim, support ribs and bottom support ridges are all made of the same inexpensive, disposable material and are integrally molded or formed as one piece. That is, the strainer of this invention can be molded by processes known in the paper industry as a single unit made of the desired paper product. Similarly, the strainer can be made by pressing a sheet of the desired metal, such as aluminum, or can be made by any similar method known to those of skill in the metal industry. Having a singular body construction allows for simplicity of manufacturing and reduced manufacturing expense.

The disposable strainer can be of virtually any size, but typically smaller sizes are of more practical use. Specifically, the strainer can be from about 3″ to about 36″ in diameter, or measured cross-wise if the strainer is not completely circular. The height of the strainer is in direct proportion to the diameter and can be from about 2-3 inches to about 8-10 inches.

The preceding preferred embodiments are illustrative of the practice of the invention. It is to be understood, however, that other expedients known to those of skill in the art, or disclosed herein, may be employed without departing from the spirit of the invention or the scope of the claims.

What is claimed is:

1. A disposable strainer capable of a limited number of uses, comprising:
a strainer body having an upper circumference defining an upper opening, sides and a closed bottom portion, said body comprising openings in the sides and bottom portion of sufficient size and shape to allow liquids and flowable solids to pass through, and
a top ring portion affixed to the upper circumference of said body,
wherein, said strainer body and said top ring are constructed from the same material and wherein said material comprises an inexpensive, disposable material intended for up to 6 uses prior to being discarded.

2. The strainer of claim 1, wherein said inexpensive, disposable material comprises paper, pulp, re-cycled paper, cardboard, plastic, biodegradeable plastic, re-cycled plastic, aluminum foil, pressed aluminum or pressable alloy metal.

3. The strainer of claim 2, wherein said strainer body comprises a generally circular or oval shape, or is in the shape of a triangle, square, or other polygon.

4. The strainer of claim 2, wherein said strainer body further comprises a plurality of vertical ribs and a at least one bottom support ridge positioned on said closed bottom portion of said body, wherein said ribs and said ridge(s) are constructed from the same material as the strainer body.

5. The strainer of claim 4, further comprising one or more handles affixed to the top ring portion.

6. The strainer of claim 4, further comprising 2 or more bottom support ridges and wherein said support ridges are spaced apart to allow liquids or solids to pass through openings between the support ridges.

7. The strainer of claim 4, wherein said vertical ribs are connected to said top ring portion and said bottom ridge(s), and wherein said vertical ribs and said bottom ridge are made from the same disposable material as said body.

8. The strainer of claim 7, wherein said top ring, said ribs and said bottom ridge(s) are integrally molded as one unit from the same inexpensive, disposable material.

9. The strainer of claim 4, wherein said disposable material comprises paper, pulp or re-cycled paper.

10. The strainer of claim 3, having a diameter of about 3 to 36 inches and a height of from about 2-3 inches to about 8 to 10 inches.

11. A plurality of disposable strainers each capable of a limited number of uses, vertically stacked one inside another, wherein each of said plurality of strainers comprises;
a strainer body having an upper circumference defining an upper opening, sides and a closed bottom portion, said body comprising openings in the sides and bottom portion of sufficient size and shape to allow liquids and flowable solids to pass through, and
a top ring portion affixed to the upper circumference of said body,
wherein, said strainer body and said top ring are constructed from the same material and wherein said material comprises an inexpensive, disposable material intended for up to 6 uses prior to being discarded.

12. The plurality of strainers of claim 11, wherein said inexpensive, disposable material comprises paper, pulp, re-cycled paper, cardboard, plastic, biodegradeable plastic, re-cycled plastic, aluminum foil, pressed aluminum or pressable alloy metal.

13. The plurality of strainers of claim 12, wherein each of said strainer bodies comprises a generally circular or oval shape, or is in the shape of a triangle, square, or other polygon.

14. The plurality of strainers of claim 12, wherein said strainer body further comprises a plurality of vertical ribs and at least one bottom support ridge positioned on said closed bottom portion of said body, wherein said ribs and said ridge(s) are constructed from the same material as the strainer body.

15. The plurality of strainers of claim 14, wherein each of said vertical ribs are connected to said top ring portion and said bottom ridge, and wherein said vertical ribs and said bottom ridge are made from the same disposable material as the body.

16. The plurality of strainers of claim 12, wherein said disposable material comprises paper, pulp or re-cycled paper.

17. The plurality of strainers of claim 14, wherein each of said strainers has a diameter of about 3 to 36 inches and a height of about 8 to 10 inches.
